(19) United States
(12) Patent Application Publication
(10) Pub. No.: US 2018/0106986 A1
(43) Pub. Date: Apr. 19, 2018

(54) External Lens Device for a Smart Device with Dual Lens Camera

(71) Applicant: Ye Xu, Sugar Land, TX (US)

(72) Inventor: Ye Xu, Sugar Land, TX (US)

(21) Appl. No.: 15/787,510

(22) Filed: Oct. 18, 2017

Related U.S. Application Data
(60) Provisional application No. 62/409,526, filed on Oct. 18, 2016.

(51) Int. Cl. G02B 13/00; G02B 7/02; G03B 17/12; G02B 15/10; G03B 17/56

(52) U.S. Cl. CPC G02B 13/0015; G02B 7/021; G03B 17/566; G02B 15/10; G03B 17/565; G03B 17/12

(57) ABSTRACT

Provided are external lens devices for a dual lens camera smart device. Generally, the external lens device comprises a lens holder, a plurality of lenses held within the lens holder and means for securing the lens holder over the dual lens camera smart device. Securing the lens holder to the dual lens camera may be effected by direct engagement of the lens holder with the dual lens camera or by a clip which when slid over the smart device positions the lens holder over the dual lens camera. Also provided are handheld camera systems with the dual lens camera smart device and the external lens device removably secured over the camera.

### CROSS-REFERENCE TO RELATED APPLICATIONS

This non-provisional application claims benefit of priority under 35 U.S.C. § 119(e) of provisional application U.S. Ser. No. 62/409,526, filed Oct. 18, 2016, the entirety of which is hereby incorporated by reference.

### BACKGROUND OF THE INVENTION

### Field of the Invention

The present invention generally relates to the field of accessories for smart devices. More specifically, the present invention relates to an external lens device used for dual-lens smart devices.

### Description of the Related Art

As digital cameras become an integrated component of smart devices, many people use their smart devices as their main cameras in every day lives. However, due to structural limitations, camera lens on a smart device has long been the bottleneck of its image quality and image complexity. Recently, a few smart device companies built smart phones with dual cameras on the back thereof in order to improve the photo-shooting capability of their smart phones. Although dual-camera may enhance the photo-shooting experience of a smart device, there are still quite a few demands for using a wide variety of camera lenses from serious or even professional photo shooters.

Therefore, there is a recognized need in the art for an external lens device that can be conveniently attached to a dual-camera smart device. Particularly, the prior art is deficient in these aspects. The present invention fulfills this long-standing need and desire in the art.

### SUMMARY OF THE INVENTION

The present invention is directed to an external lens device for a dual lens camera on a smart device. The external lens device comprises a lens holder, a plurality of lenses held within the lens holder and means for securing the lens holder over the dual-camera smart device.

The present invention also is directed to a related external lens device. The external lens device comprises a base plate, a lens disposed in each of the two base openings and a top plate. The base plate comprises a recessed front surface, a recessed back surface configured to removably engage a projection circumferentially disposed around the dual lens camera on the smart device and two base openings disposed through the recessed front surface and the back surface. The top plate comprises a front surface, a back surface disposed in an abutting relationship with the recessed front surface of the base plate such that the two top openings align with the two base openings and two top openings disposed through the front surface and the back surface.

The present invention is directed further to another related external lens device. The external lens device comprises a lens holder and a substantially U-shaped clip with a first end and a second end. The lens holder comprises a front plate with a front surface and a recessed back surface and two front openings disposed therethrough, a pair of lens assemblies each containing one or more of a plurality of lenses where each lens assembly is disposed within one of the two front openings on the front plate and a back plate with two back openings therethrough disposed in an abutting relationship with the recessed back surface of the front plate such that the two back openings align with the lens assemblies. The U-shaped clip comprises a lens holder receiving portion formed on the first end and comprising an open frame structure with a second flange circumferentially extending from an inner surface thereof and in an abutting relationship with the lens holder and a clip base formed on the second end.

The present invention is directed further still to a handheld camera system. The handheld camera system comprises a smart device, such as a smart phone or tablet, comprising a dual lens camera and the external lens device, as described herein, removably securable over the dual lens camera.

Other and further aspects, features, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1B are exploded perspective views of one embodiment of the external lens for a dual-camera smart device.

FIG. 2 is an assembled view of FIGS. 1A-1B.

FIG. 3 is a cross-sectional view of FIG. 2.

FIG. 4 is a perspective view of the back of a smart device showing a dual lens camera.

FIGS. 5A-5B are perspective views that illustrate securing the external lens device of FIG. 2 over the dual camera lenses on the smart device.

FIGS. 6A-6C are exploded perspective views of another embodiment of the external lens for a dual-camera smart device.

FIG. 7 is an assembled view of FIGS. 6A-6C.

FIGS. 8A-8B are perspective views that illustrate securing the external lens device of FIG. 7 over the dual camera lenses on the smart device.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

In one embodiment of the present invention, there is provided an external lens device for a dual lens camera on a smart device, comprising a lens holder; a plurality of lenses held within the lens holder; and means for securing the lens holder over the dual-camera smart device. In this embodiment the plurality of lenses may comprise a wide-angle lens, a telephoto lens or a fisheye lens.

In one aspect of this embodiment the lens holder may comprise a base plate comprising a recessed front surface and a recessed back surface and two base openings disposed through the recessed front surface and the back surface each with a diameter sufficient to contain one or more of the plurality of lenses therein; and a top plate comprising a front surface and a back surface and two top openings through the front surface and the back surface, where the back surface is disposed in an abutting relationship with the recessed front surface of the base plate such that the two top openings align with the lens holders. In this aspect the securing means may comprise the recessed back surface disposed on the base plate configured to removably engage a projection circumferentially disposed around the dual lens camera on the smart device.

In another aspect of this embodiment the lens holder may comprise a pair of lens assemblies each containing one or more of the plurality of lenses; a front plate comprising a front surface and a recessed back surface and two front openings disposed through the front surface and the recessed back surface each with a diameter sufficient to contain one of the pair of lens assemblies therein; and a back plate comprising two back openings therethrough disposed in an abutting relationship with the recessed back surface of the front plate where the two back openings align with the lens assemblies.

In this aspect each of the lens assemblies in the pair may comprise a plurality of lenses; a pair of inner lens frames each comprising an open front surface and an open back surface, each of said open front surfaces having a diameter sufficient to contain one of the plurality of lens therein; a pair of outer lens frames each comprising an open front surface, an open back surface and a first flange circumferentially extending from an interior surface thereof, where each of the open front surfaces having a diameter sufficient to contain another of the plurality of lenses and one of the pair of inner lens frames therein. Particularly, the open back surface of the inner lens frame may have a diameter that is smaller than the diameter of the open front surface thereof. Also in this aspect the lens contained in the outer lens frame may be in an abutting relationship with the first flange and the open back surface of the inner lens frame may be in an abutting relationship with the lens in the outer lens frame such that the lenses disposed in the inner lens frame and outer lens frame are in alignment. In addition in this aspect the securing means may comprise a substantially U-shaped clip comprising a first end and a second end; a lens holder receiving portion formed on the first end; and a clip base formed on the second end. Particularly the lens holder receiving portion may comprise an open frame structure with a second flange circumferentially extending from an inner surface thereof and having dimensions sufficient to removably secure the lens holder therein in an abutting relationship with the second flange.

In another embodiment of the present invention there is provided a handheld camera system, comprising a smart device with a dual lens camera; and the external lens device, as described supra, removably securable over the dual lens camera. In this embodiment the smart device may be a smart phone or a tablet.

In yet another embodiment of the present invention there is provided an external lens device for a dual lens camera on a smart phone, comprising a base plate comprising a recessed front surface; a recessed back surface configured to removably engage a projection circumferentially disposed around the dual lens camera on the smart device; two base openings disposed through the recessed front surface and the back surface; a lens disposed in each of the two base openings; and a top plate comprising a front surface; a back surface disposed in an abutting relationship with the recessed front surface of the base plate such that the two top openings align with the two base openings; and two top openings disposed through the front surface and the back surface. In this embodiment the plurality of lenses may comprise a wide-angle lens, a telephoto lens or a fisheye lens.

In yet another embodiment of the present invention there is provided a handheld camera system, comprising a smart phone with a dual lens camera; and the external lens device, as described supra, removably securable over the dual lens camera on the smart phone such that the recessed back surface of the base plate removably engages a projection disposed around the dual lens camera on the smart phone.

In yet another embodiment of the present invention there is provided an external lens device for a dual lens camera on a smart phone, comprising a lens holder comprising a front plate with a front surface and a recessed back surface and two front openings disposed therethrough; a pair of lens assemblies each containing one or more of a plurality of lenses, each lens assembly disposed within one of the two front openings on the front plate; a back plate with two back openings therethrough disposed in an abutting relationship with the recessed back surface of the front plate such that the two back openings align with the lens assemblies; and a substantially U-shaped clip with a first end and a second end, comprising a lens holder receiving portion formed on the first end and comprising an open frame structure with a second flange circumferentially extending from an inner surface thereof and in an abutting relationship with the lens holder; and a clip base formed on the second end.

In this embodiment each of the lens assemblies in the pair may comprise a plurality of lenses; an inner lens frame comprising an open front surface and an open back surface and containing one of the plurality of lenses therein; an outer lens frame comprising an open front surface, an open back surface and a first flange circumferentially extending from an interior surface thereof, where the open front surface has another of the plurality of lenses and the inner lens frames disposed therein. Particularly, the open back surface of the inner lens frame may have a diameter that is smaller than the diameter of the open front surface thereof. Also in this embodiment the plurality of lenses may comprise a wide-angle lens, a telephoto lens or a fisheye lens.

In yet another embodiment of the present invention there is provided a handheld camera system, comprising a smart phone with a dual lens camera; and the external lens device, as described supra, where the U-shaped clip thereof is removably securable over the dual lens camera on the smart phone such that the lens assemblies comprising the lens holder are positioned on a smart phone surface with the camera in alignment with the dual lenses thereon and the clip base is disposed against an opposite surface of the smart phone.

Provided herein is an external lens device for providing extra lenses for a dual-camera smart device. Generally, the external lens device is configured to contain a plurality of lenses which can be disposed over the camera lenses on a dual lens smart device, such as, but not limited to, a dual lens smart phone. The external lens device comprises a lens holder and a means for securing it to the smart device. For example, the securing means may comprise a snap-like combination where the device is configured to engage a projection formed around the dual lenses on the smart device. The securing means may comprise the lens holder and may be a recess formed on the back surface of external lens device, which fits over the projection. Alternatively, the securing means may comprise a flexible clip or clip-like extension formed on the external lens device that slides over the edge of the smart device to position the external lens device.

The plurality of lenses may comprise, for example, a wide-angle lens, a telephoto lens or a fisheye lens. The lens holder may contain a pair of lenses or more in different combinations. The smart device may be a smart phone or a tablet. Thus, also provided is a handheld camera system comprising the smart device with the external dual lens device positioned thereon. The external dual lens device is easily secured to and removed from the smart device by a user. The external dual lens device is small, lightweight and portable.

Particularly, embodiments of the present invention are better illustrated with reference to the Figure(s), however, such reference is not meant to limit the present invention in any fashion. The embodiments and variations described in detail herein are to be interpreted by the appended claims and equivalents thereof.

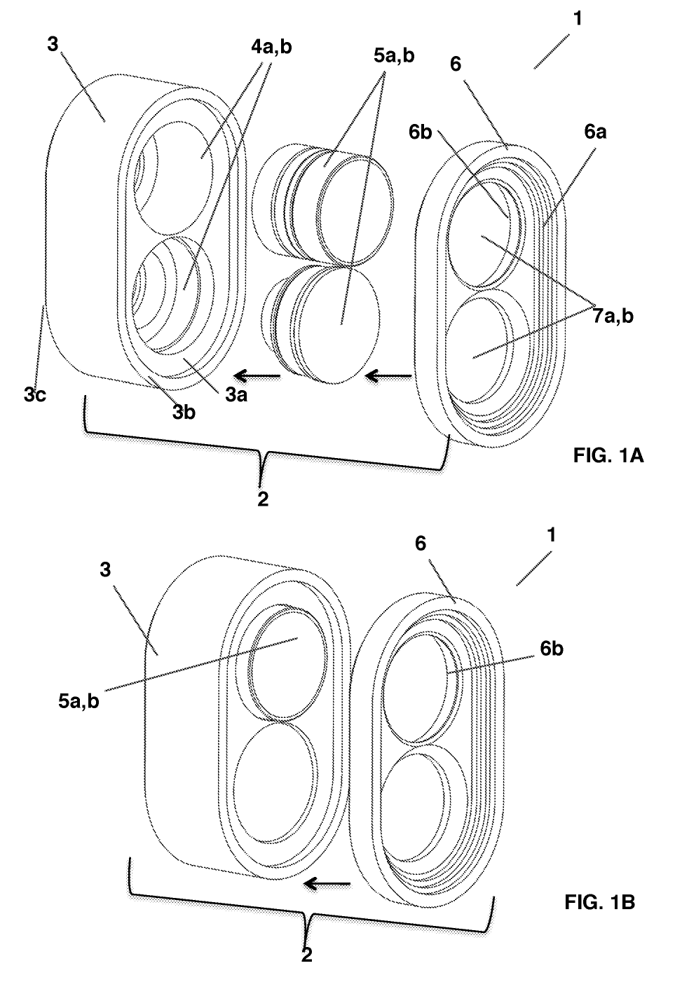

FIGS. 1A-1B show the component parts of one embodiment of the dual lens device. FIG. 1A shows that the dual lens device 1 comprises a lens holder 2 and a means for securing the lens holder onto the dual-camera on a smart device which in this embodiment comprises a feature of the lens holder. The lens holder comprises a base plate 3 having a front surface 3a with a rim 3b circumferentially disposed on the front surface thereby forming a recessed surface thereon and a recessed back surface 3c corresponding to recessed surface 3a. The front surface 3a comprises two base openings 4a,b disposed therethrough. A pair of lenses, represented by 5a,b are configured to fit within the two base openings. A top plate 6 has a front surface 6a and has a back surface 6b configured to fit within and abut the recess formed by the rim 3b base plate and secure the lenses in the openings. Two top openings 7a,b are disposed through the top plate and are substantially, longitudinally coaxial with, but with a smaller diameter than, the diameter of the base openings 4a,b of the base plate such that the lenses 5a,b are secured within the base plate by the top plate. FIG. 1B is a partially assembled view of the dual lens device 1. The lenses 5a,b are disposed within the base openings 4a,b in the base plate 3. The top plate 6 is shown with the back surface 6b in alignment with the recessed front surface 3a and with the top openings 7a,b in alignment with the base openings prior to securing it within the base plate.

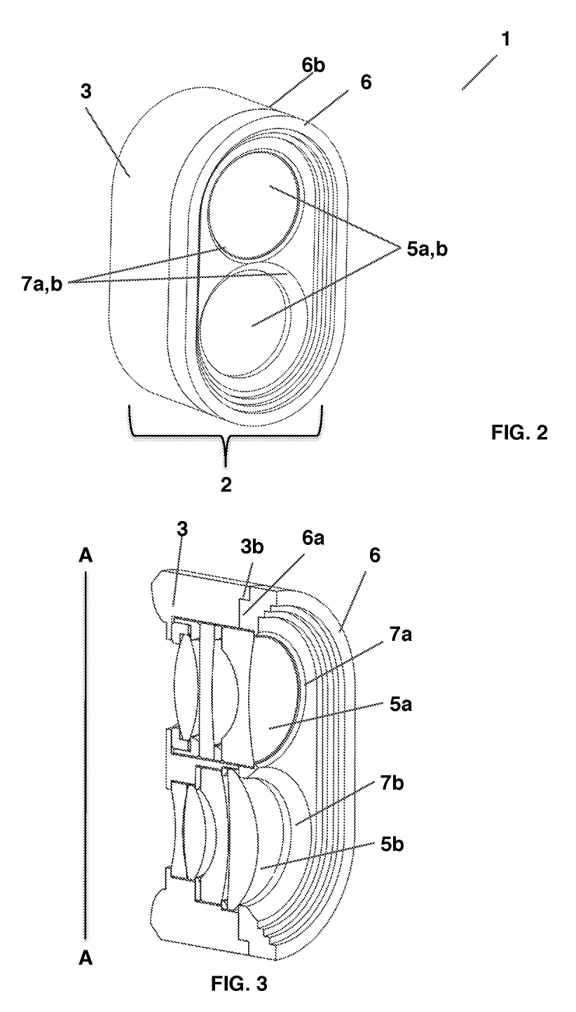

With continued reference to FIGS. 1A-1B, FIG. 2 is a perspective view of the assembled dual lens device 1. When the openings 7a,b of the top plate 6 are aligned with the lenses 5a,b disposed within the base plate 3 at openings 4a,b, the back surface of the top plate fits within the front surface 3a circumscribed by the rim 3a on the front surface of the back plate (see FIG. 3). It is contemplated that a user can switch the lenses by removing the top plate from the base plate and exchanging the lenses disposed in the openings.

With continued reference to FIG. 2, FIG. 3 is a cross-sectional view along the axis A-A. The view illustrates how the back surface 6b of the top plate 6 securely fits within the recess formed by the rim 3b on the back plate 3 such that the lenses 5a,b align with the openings 7a,b on the top plate. The top plate 6 is secured over the base plate 3 and the lenses 5a,b are retained within the openings through the base plate and the top plate.

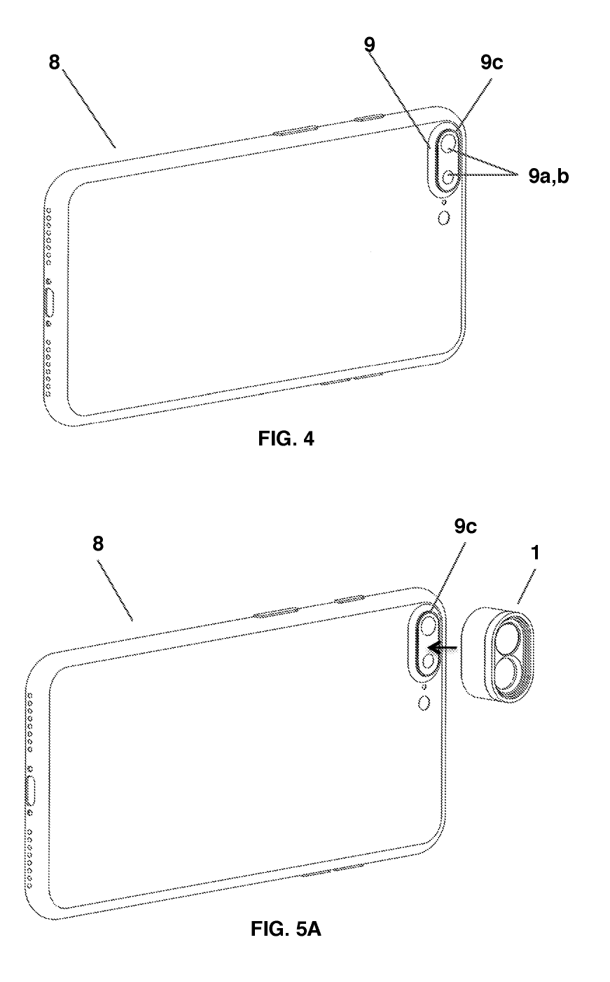

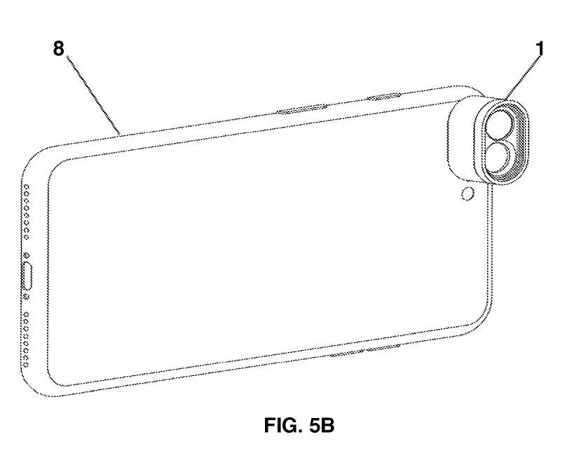

FIG. 4 shows a smart device 8 comprising a dual lens camera 9. The dual lens camera comprises a projection 9c circumferentially formed around the dual lenses 9a,b.

With continued reference to FIG. 2, FIGS. 5A-5B illustrate placement of the external dual lens device over the dual lens camera 9 on the smart device 8. In FIG. 5A, the external lens device 1 is aligned with the projection 9c on the dual lens camera. The recessed back surface 3c of the external lens device engages the projection therewithin to securely, but removably, attach thereto. FIG. 5B illustrates the external lens device 1 as secured in a covering relationship to the smart device dual lens camera. When the external lens device is secured over the smart device, the lenses are substantially co-axial to the camera lenses of the smart device. The length of the base plate and the top plate may be adjusted to vary dimensions to fit over dual lens cameras with different sizes and dimensions.

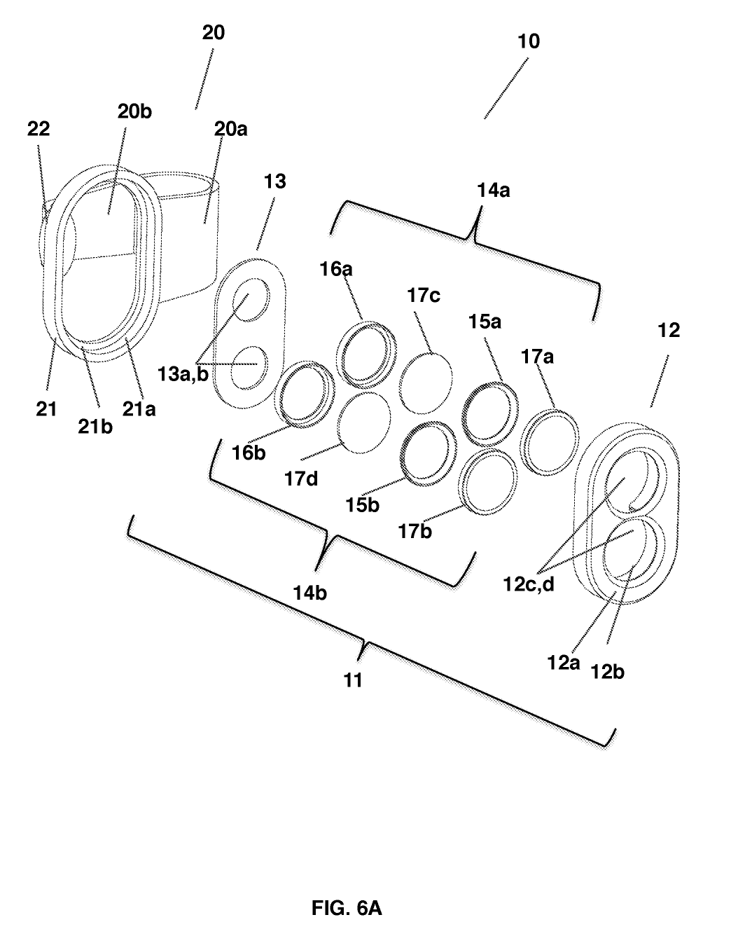

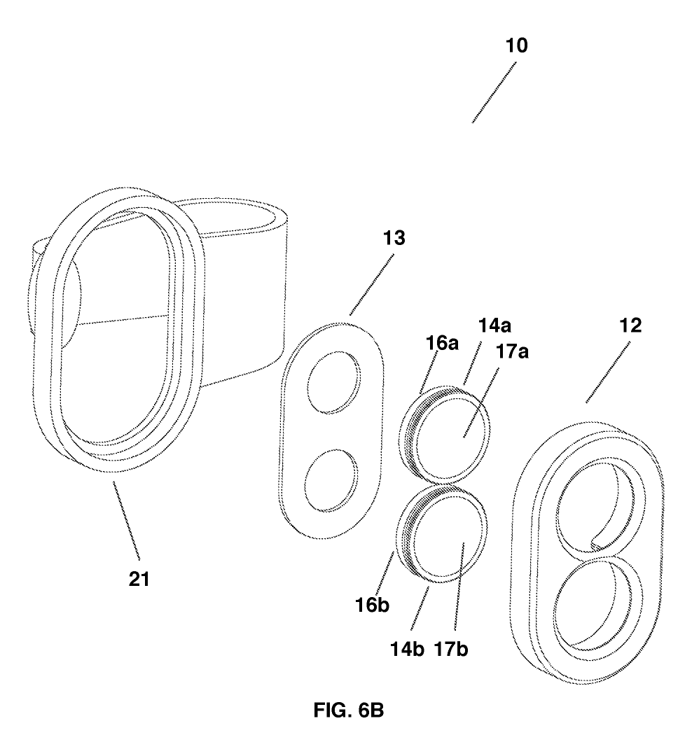

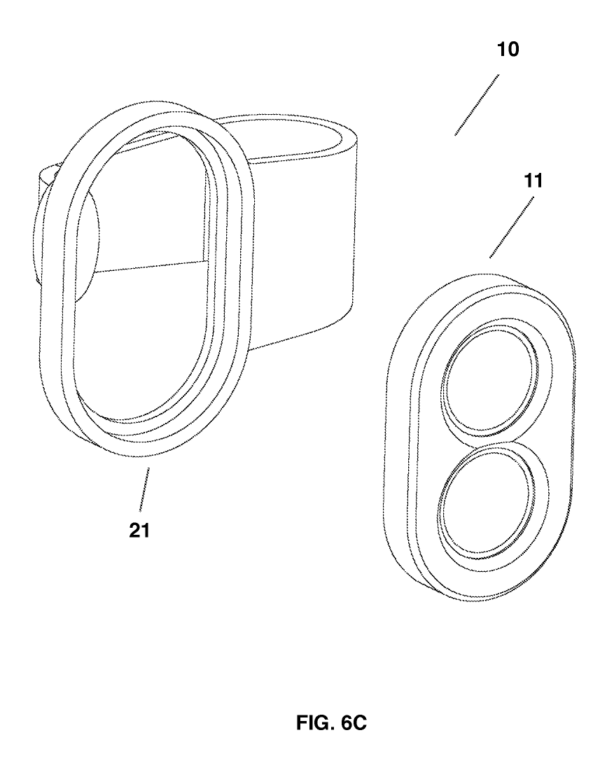

FIGS. 6A-6C show the component parts of another embodiment of the external dual lens device 10. In FIG. 6A the external dual lens device comprises a lens holder 11 and a clip 20. The clip is configured to securely engage the lens assembly. The lens holder comprises a front plate 12, a back plate 13 and lens assemblies 14a,b. The front plate comprises a front surface 12a and a back surface 12b recessed from the back edge thereof and comprises front openings 12c,d therethrough. The front plate is configured to receive and to secure the lens assemblies 14a,b therein. The back plate 13 comprises back openings 13a,b and has dimensions to securely fit within the recessed back surface 12b of the front plate. When the back plate is disposed within the front plate, the back openings 13a,b are aligned with lens assemblies 14a,b disposed within the front plate 12.

The lens assemblies 14a,b each comprise an inner lens frame 15a,b, an outer lens frame 16a,b and a plurality of lenses, represented by 17a,b,c,d. The inner lens frame has a diameter across its open front surface sufficient to receive a lens 17a,b therein and a diameter across its open back surface less than that at the front surface. The outer lens frame has a first flange 16c extending circumferentially from the inner surface thereof and has a diameter across the open front surface to receive lens 17c,d to abut flange 16c and to receive the inner lens frame 15a,b containing lens 17a,b therein.

The clip 20 has a substantially U-shaped band-like body with arms 20a,b. A lens assembly receiving portion 21 is formed at a first end of arm 20a and a substantially circular clip base 22 is formed at a second end of arm 20b. The lens assembly receiving portion comprises an open frame structure configured to receive and retain the lens holder 11 therein. The inner surface 21a of the open frame has a second flange 21b circumferentially formed thereon such that the back of the lens assembly 11 abuts the second flange when securely disposed therein.

FIG. 6B is a partially assembled view of the external lens device 10. The lens assemblies 14a,b are assembled illustrating the position of the outer lens frame 16a,b containing the lenses 17c,d and inner lens frame containing the lenses 17a,b such that only lens 17a,b is visible. The alignment of the lens assemblies with the front plate 12, the alignment of the back plate 13 with the lens assemblies and their alignment with the lens assembly receiving portion 21 for assembly is illustrated. FIG. 6C is a partially assembled view showing the assembled lens holder 10 in alignment with the lens assembly receiving portion 21 for final assembly.

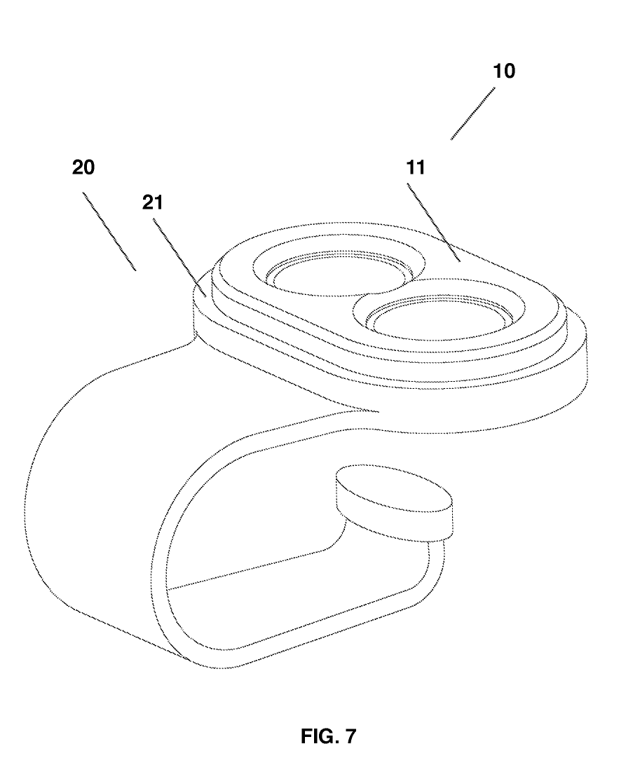

With continued reference to FIGS. 6A-6C, FIG. 7 shows the lens holder 11 securely disposed within the lens assembly receiving portion 21 on the clip 20. It is contemplated that a user can push the lens assembly out of the receiving portion from the back thereof to replace it with a lens assembly comprising different lenses.

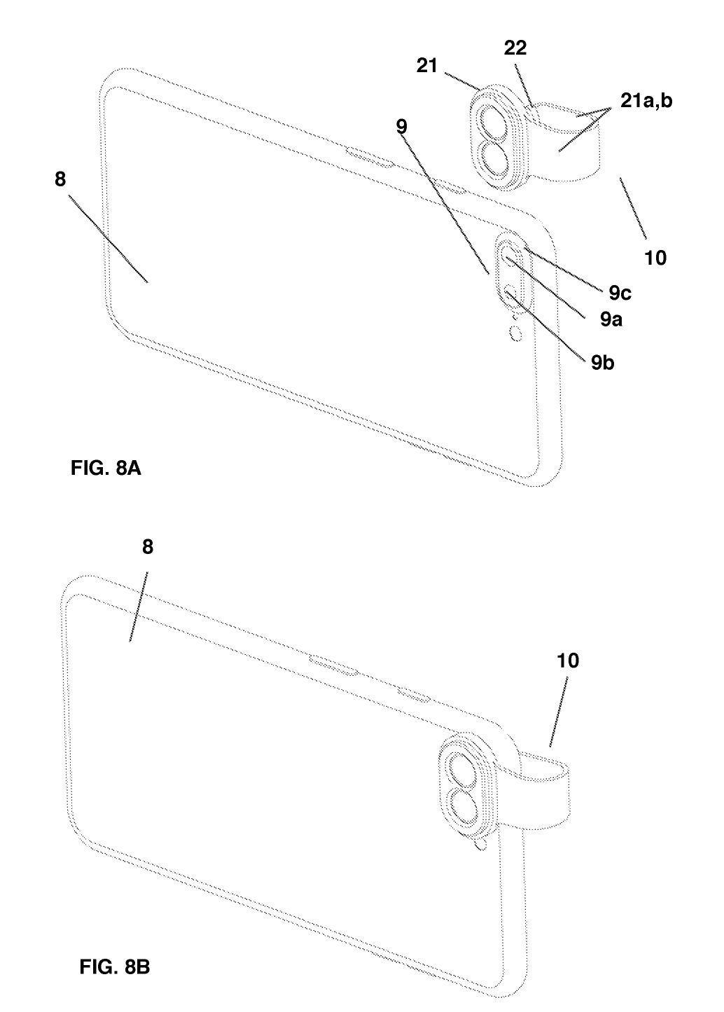

With continued reference to FIG. 7, FIGS. 8A-8B illustrate placement of the external dual lens on the smart device 8 comprising the dual lens camera 9. In FIG. 8A the external dual lens device 10 is aligned with the camera side of the smart device such that when slid along the side, the edge of the smart device is disposed between arm 21a,b. The projection 9c disposed circumferentially around the dual lenses 9a,b on the dual lens camera abuts against the back of flange 21b and the clip base 22 is disposed against the opposite surface of the smart device to maintain the position of the clip (see FIG. 6A). FIG. 8B illustrates the external lens device 10 in a covering relationship to the smart device 8 dual lens camera where the lenses 17a,b,c,d within the lens assemblies 14a,b (see FIGS. 6A-6C) are substantially aligned with the dual camera lenses 9a,b (see FIG. 8A) of the smart device. The length of the lens assembly and the dimensions of the lens assembly receiving portion may be adjusted to fit over dual lens cameras with different sizes and dimensions.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. An external lens device for a dual lens camera on a smart device, comprising:
a lens holder;
a plurality of lenses held within the lens holder; and
means for securing the lens holder over the dual lens camera on the smart device.

2. The external lens device of claim 1, said lens holder comprising:
a base plate comprising a recessed front surface and a recessed back surface and two base openings disposed through said recessed front surface and said back surface each with a diameter sufficient to contain one or more of the plurality of lenses therein; and
a top plate comprising a front surface and a back surface and two top openings through said front surface and said back surface, said back surface disposed in an abutting relationship with the recessed front surface of the base plate such that the two top openings align with the lens holders.

3. The external lens device of claim 2, said securing means comprising the recessed back surface disposed on the base plate configured to removably engage a projection circumferentially disposed around the dual lens camera on the smart device.

4. The external lens device of claim 1, said lens holder comprising:
a pair of lens assemblies each containing one or more of the plurality of lenses;
a front plate comprising a front surface and a recessed back surface and two front openings disposed through said front surface and said recessed back surface each with a diameter sufficient to contain one of the pair of lens assemblies therein; and
a back plate comprising two back openings therethrough disposed in an abutting relationship with the recessed back surface of the front plate where the two back openings align with the lens assemblies.

5. The external lens device of claim 4, each of said lens assemblies in the pair comprising:
a plurality of lenses;
a pair of inner lens frames each comprising an open front surface and an open back surface, each of said open front surfaces having a diameter sufficient to contain one of the plurality of lens therein;
a pair of outer lens frames each comprising an open front surface, an open back surface and a first flange circumferentially extending from an interior surface thereof, each of said open front surfaces having a diameter sufficient to contain another of the plurality of lenses and one of the pair of inner lens frames therein.

6. The external lens device of claim 4, wherein the open back surface of the inner lens frame has a diameter that is smaller than the diameter of the open front surface thereof.

7. The external lens device of claim 4, wherein the lens contained in the outer lens frame is in an abutting relationship with the first flange and the open back surface of the inner lens frame is in an abutting relationship with the lens in the outer lens frame such that the lenses disposed in the inner lens frame and outer lens frame are in alignment.

8. The external lens device of claim 4, said securing means comprising:
a substantially U-shaped clip comprising a first end and a second end;
a lens holder receiving portion formed on the first end; and
a clip base formed on the second end.

9. The external lens device of claim 8, said lens holder receiving portion comprising:
an open frame structure with a second flange circumferentially extending from an inner surface thereof and having dimensions sufficient to removably secure the lens holder therein in an abutting relationship with the second flange.

10. The external lens device of claim 1, wherein the plurality of lenses comprises a wide-angle lens, a telephoto lens or a fisheye lens.

11. A handheld camera system, comprising:
a smart device with a dual lens camera; and
the external lens device of claim 1 removably securable over the dual lens camera.

12. The external lens device of claim 1, wherein the smart device is a smart phone or a tablet.

13. An external lens device for a dual lens camera on a smart phone, comprising:
a base plate comprising:
a recessed front surface;
a recessed back surface configured to removably engage a projection circumferentially disposed around the dual lens camera on the smart device;
two base openings disposed through said recessed front surface and said back surface;
a lens disposed in each of the two base openings; and
a top plate comprising:
a front surface;
a back surface disposed in an abutting relationship with the recessed front surface of the base plate such that the two top openings align with the two base openings; and
two top openings disposed through said front surface and said back surface.

14. The external lens device of claim 1, wherein the plurality of lenses comprises a wide-angle lens, a telephoto lens or a fisheye lens.

15. A handheld camera system, comprising:
a smart phone with a dual lens camera; and
the external lens device of claim 13, removably securable over the dual lens camera on the smart phone such that the recessed back surface of the base plate removably engages a projection disposed around the dual lens camera on the smart phone.

16. An external lens device for a dual lens camera on a smart phone, comprising:
a lens holder comprising:
a front plate with a front surface and a recessed back surface and two front openings disposed therethrough;
a pair of lens assemblies each containing one or more of a plurality of lenses, each lens assembly disposed within one of the two front openings on the front plate;
a back plate with two back openings therethrough disposed in an abutting relationship with the recessed back surface of the front plate such that the two back openings align with the lens assemblies; and
a substantially U-shaped clip with a first end and a second end, comprising:
a lens holder receiving portion formed on the first end and comprising an open frame structure with a second flange circumferentially extending from an inner surface thereof and in an abutting relationship with the lens holder; and
a clip base formed on the second end.

17. The external dual lens device of claim 16, each of said lens assemblies in the pair comprising:
a plurality of lenses;
an inner lens frame comprising an open front surface and an open back surface and containing one of the plurality of lenses therein; and
an outer lens frame comprising an open front surface, an open back surface and a first flange circumferentially extending from an interior surface thereof, said open front surface having another of the plurality of lenses and the inner lens frames disposed therein.

18. The external lens device of claim 17, wherein the open back surface of the inner lens frame has a diameter that is smaller than the diameter of the open front surface thereof.

19. The external dual lens device of claim 16, wherein the plurality of lenses comprises a wide-angle lens, a telephoto lens or a fisheye lens.

20. A handheld camera system, comprising:
a smart phone with a dual lens camera; and
the external lens device of claim 16, said U-shaped clip thereof removably securable over the dual lens camera on the smart phone such that the lens assemblies comprising the lens holder are positioned on a smart phone surface with the camera in alignment with the dual lenses thereon and the clip base is disposed against an opposite surface of the smart phone.
